(19) United States
(12) Patent Application Publication
(10) Pub. No.: US 2008/0178278 A1
(43) Pub. Date: Jul. 24, 2008

(54) Providing A Generic Gateway For Accessing Protected Resources

(76) Inventors: Doron Grinstein, Valley Village, CA (US); Eric N. Kotler, Sherman Oaks, CA (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 11/625,514

(22) Filed: Jan. 22, 2007

(51) Int. Cl. G06F 21/00

(52) U.S. Cl. 726/12

(57) ABSTRACT

An internal gateway establishes persistent connections to an external gateway through permitted ports and protocols of a firewall. Software on the external gateway and the internal gateway collaborate in order to make available internal, firewall-protected resources to external clients securely and without having to modify network or firewall configurations. Any computing resource such as a web service, web application, or any other network addressable resource residing behind a firewall can be securely exposed in a generic fashion to clients on the external network. No special software is required by clients.

### BACKGROUND

An organization may create or acquire software that resides on a protected (private) network. Because a private network is typically protected by a firewall, the software on the private network is usually not accessible to entities (clients) that reside on or attempt to access the software via an external network. An external network may be a public network such as the Internet or an internal network separated from the private network because of a security concern, perhaps belonging to another organization or a different department. The software on the private network may comprise or include web services, web applications, rich client applications, message-related systems such as email, instant messaging or other data-transfer and computing-related applications, which may require the use of TCP/IP ports or UDP ports utilizing any of a broad array of protocols. Frequently, after the software is deployed on the private network, the organization finds it advantageous to be able to expose the software to computing devices that reside on the external network.

Various options are currently available that enable specific types of applications to be exposed to external clients, but these options are tailored to individual applications and are not generic in nature or they may require changes to network configuration such as opening up ports in firewalls, or installing specialized firewalls that bypass the primary firewall or utilize an existing firewall but require a configuration change of the firewall settings. Examples of these tailored solutions include Citrix's GoToMyPC.com service. This service allows users with specific known credentials (such as user id and password, for example) to access a specific remote WINDOWS-based computer from a user's computer. The user is able to see the screen of the remote computer and type input using the keyboard and mouse of the remote user's computer. This capability is very different from exposing a network resource such as a web service, web application, TCP/IP port and such. In cases where services need to be exposed to business partners, for example, such as a SOAP-based web service which takes in an item number and returns an inventory level, or an FTP service which accepts file uploads and downloads, machine-to-machine communication capabilities are needed, not human-screen-keyboard-mouse interactions. Using the method utilized by GoToMyPC.com, the screen representation and input-device change data are transferred from a first computer to a second computer, but computer services such as web services, TCP or UDP ports, etc. of the first computer are not exposed to the second computer.

Other known options involve the utilization of special kinds of firewall devices which selectively allow certain traffic from an external network to access software on a private network. The firewall inspects the data being transmitted and only allows authorized packets to flow inward. This type of interaction is initiated directly from the computer on the external network. Authorized data is allowed to flow through the firewall into the protected (internal) network. This approach, while workable, requires organizations to make changes to their network and security configuration, allowing the new firewall direct access to both the external network or networks and the private network. This in many cases represents a violation of the organization's security policies. It is also costly in terms of network engineering personnel. Depending on the expertise of the network personnel, the quality of the device, its software and how it is maintained, it is also a source of serious security risks.

### SUMMARY

An internal gateway establishes persistent connections to an external gateway through permitted ports and protocols of a firewall or other physical or logical barrier. Software on the external gateway and the internal gateway collaborate in order to make available internal, firewall-protected resources to external clients securely and without having to modify network or firewall configurations. Any computing resource such as a web service, web application, or any other network addressable resource residing behind a firewall can be securely exposed in a generic fashion to clients on the external network. Endpoints may be exposed without requiring external clients to use additional software. Although, in some situations, an optional client-side proxy software may be utilized to provide additional services.

Utilizing typically-open ports such as port 80 or port 443, an internal gateway connects via existing firewalls or other physical or logical barriers between a protected internal resource and an external entity via an external gateway. The external gateway appears to the external entity to be the protected internal resource. A policy exception that allows traffic from an external network into a private network is not required. The need to “open up” the network configuration to allow incoming traffic from the external network is eliminated. Any computing resource (including a web service, a web application, or any other network-addressable resource) residing behind a firewall can be securely exposed in a generic fashion to clients on an external network without reconfiguring network equipment such as routers, firewalls, etc.

A generic gateway system facilitates secure exposure of computing services residing on a protected network. The computing services may be protected by a security device such as a firewall, and thus be normally inaccessible to clients situated outside the protected network. The generic gateway system prevents unauthorized access by clients who do not possess sufficient rights, as designated by the provider/administrator of the computing services being exposed, but allows a client who possesses sufficient rights to access the protected resources. The generic gateway system enables access to protected resources by an authorized client while complying with standard security policies that prohibit clients on the external network from initiating a direct request or communication session with computing services on the protected network because the generic gateway initiates communications from within the protected network to the external gateway situated on the external network.

### BRIEF DESCRIPTION OF THE DRAWINGS

In the drawings:

FIG. 1a is a block diagram illustrating an exemplary computing environment in which aspects of the invention may be implemented;

FIG. 1b is a block diagram illustrating an exemplary networking environment in which aspects of the invention may be implemented;

FIG. 2 is another block diagram of a system for providing a generic gateway for accessing protected resources in accordance with some embodiments of the invention;

FIG. 3 is another block diagram of a system for providing a generic gateway for accessing protected resources in accordance with some embodiments of the invention;

FIG. 4 is a flow diagram of a method for providing a generic gateway for accessing protected resources in accordance with some embodiments of the invention;

FIG. 5 is another flow diagram of aspects of a method for providing a generic gateway for accessing protected resources in accordance with some embodiments of the invention;

FIG. 6 is a flow diagram of aspects of a method for providing a generic gateway for accessing protected resources in accordance with some embodiments of the invention;

FIG. 7 is a flow diagram of aspects of a method for providing a generic gateway for accessing protected resources in accordance with some embodiments of the invention;

FIG. 7 is a flow diagram of aspects of a method for providing a generic gateway for accessing protected resources in accordance with some embodiments of the invention;

FIG. 8 is a flow diagram of aspects of a method for providing a generic gateway for accessing protected resources in accordance with some embodiments of the invention;

FIG. 9 is a flow diagram of aspects of a method for providing a generic gateway for accessing protected resources in accordance with some embodiments of the invention;

FIG. 10 is a flow diagram of aspects of a method for providing a generic gateway for accessing protected resources in accordance with some embodiments of the invention;

FIG. 11 is a flow diagram of aspects of a method for providing a generic gateway for accessing protected resources in accordance with some embodiments of the invention;

FIG. 12 is a flow diagram of aspects of a method for providing a generic gateway for accessing protected resources in accordance with some embodiments of the invention;

FIG. 13 is a flow diagram of aspects of a method for providing a generic gateway for accessing protected resources in accordance with some embodiments of the invention; and

FIG. 14 is a flow diagram of aspects of a method for providing a generic gateway for accessing protected resources in accordance with some embodiments of the invention.

### DETAILED DESCRIPTION

### Overview

Most organizations that create web services or web applications provide these resources to their internal clients (i.e., clients situated behind a firewall on an internal network). The firewall prevents access to the resources by external clients (clients residing on external networks). An organization may want to expose these resources to external entities in a controlled fashion. A significant amount of engineering is required to allow an external client to access a firewall-protected resource, especially when policies are in place which state that connections from an external network should not be allowed to penetrate the internal network. Typically, to enable external clients to access a protected internal resource, the organization replicates the application servers, database servers and any other servers that are used to implement the internal service or application outside of their firewall. The external client accesses the replicated services. A scheduled task then synchronizes data between the external and internal systems. This solution is cumbersome and costly. In other scenarios, organizations re-configure their networks to allow inbound traffic from the external network into the internal network. Often this is accomplished by using devices known as XML Firewalls that inspect incoming traffic and restrict access based on a set of rules.

Significant cost savings to an organization may be realized because instead of duplicating the hardware and software necessary for exposing the desired services and moving data from the external system to the internal system and vice versa or “poking holes” in the network firewall to allow connections to be initiated from the external network to the internal network, embodiments of the invention provide user-controlled access to protected resources while prohibiting direct connection from the external network to resources on the internal network.

### Exemplary Computing Environment

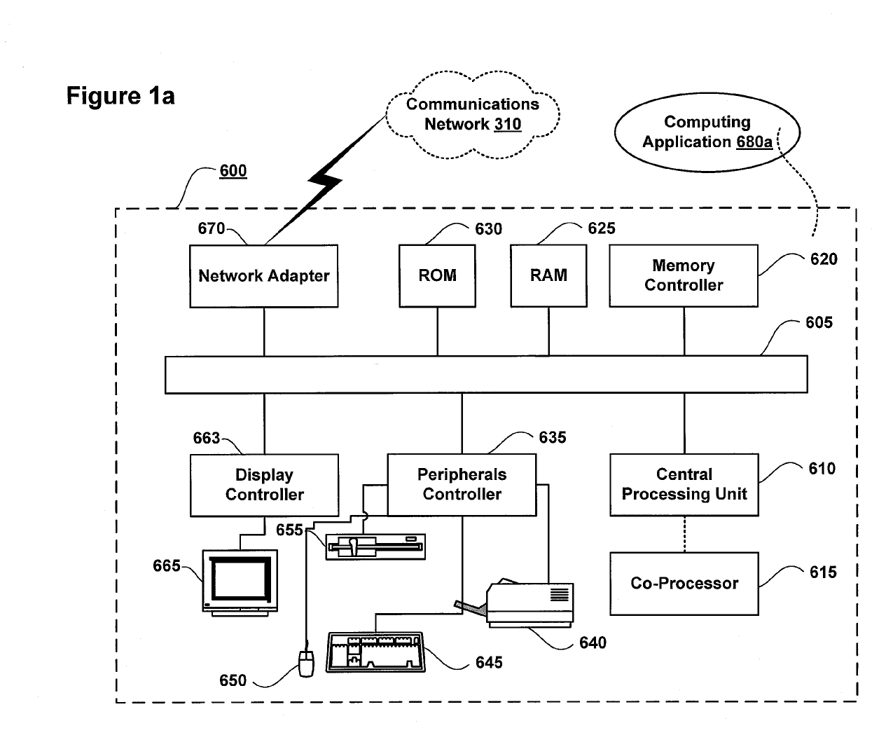

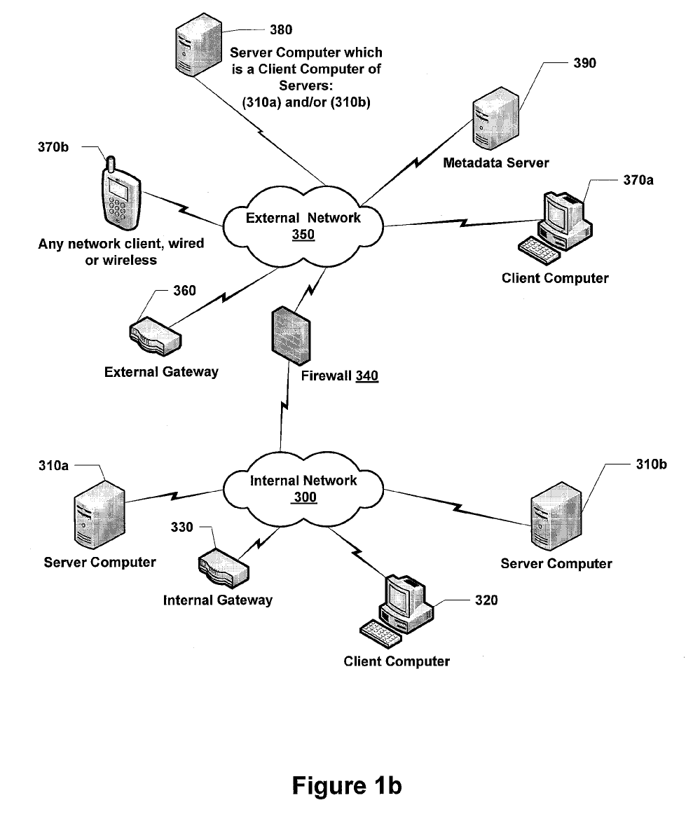

FIG. 1a depicts an exemplary computing system 600 in accordance with the invention. Computing system 600 executes an exemplary computing application 680a for providing a generic gateway for accessing protected resources in accordance with the invention. Exemplary computing system 600 is controlled primarily by computer-readable instructions, which may be in the form of software, wherever, or by whatever means such software is stored or accessed. Such software may be executed within central processing unit (CPU) 610 to cause data processing system 600 to do work. In many known workstations and personal computers central processing unit 610 is implemented by a single-chip CPU called a microprocessor. Coprocessor 615 is an optional processor, distinct from main CPU 610, that performs additional functions or assists CPU 610. One common type of coprocessor is the floating-point coprocessor, also called a numeric or math coprocessor, which is designed to perform numeric calculations faster and better than general-purpose CPU 610. Recently, however, the functions of many coprocessors have been incorporated into more powerful single-chip microprocessors.

In operation, CPU 610 fetches, decodes, and executes instructions, and transfers information to and from other resources via the computer's main data-transfer path, system bus 605. Such a system bus connects the components in computing system 600 and defines the medium for data exchange. System bus 605 typically includes data lines for sending data, address lines for sending addresses, and control lines for sending interrupts and for operating the system bus. An example of such a system bus is the PCI (Peripheral Component Interconnect) bus. Some of today's advanced busses provide a function called bus arbitration that regulates access to the bus by extension cards, controllers, and CPU 610. Devices that attach to these busses and arbitrate to take over the bus are called bus masters. Bus master support also allows multiprocessor configurations of the busses to be created by the addition of bus master adapters containing a processor and its support chips.

Memory devices coupled to system bus 605 include random access memory (RAM) 625 and read only memory (ROM) 630. Such memories include circuitry that allow information to be stored and retrieved. ROMs 630 generally contain stored data that cannot be modified. Data stored in RAM 625 can be read or changed by CPU 610 or other hardware devices. Access to RAM 625 and/or ROM 630 may be controlled by memory controller 620. Memory controller 620 may provide an address translation function that translates virtual addresses into physical addresses as instructions are executed. Memory controller 620 also may provide a memory protection function that isolates processes within the system and isolates system processes from user processes. Thus, a program running in user mode can access only memory mapped by its own process virtual address space; it cannot access memory within another process's virtual address space unless memory sharing between the processes has been set up.

In addition, computing system 600 may contain peripherals controller 635 responsible for communicating instructions from CPU 610 to optional peripherals, such as, printer 640, keyboard 645, mouse 650, and disk drive 655.

Display 665, (optional), is controlled by display controller 663, is used to display visual output generated by computing system 600. Such visual output may include text, graphics, animated graphics, and video. Optional Display 665 may be implemented with a CRT-based video display, an LCD-based flat-panel display, gas plasma-based flat-panel display, or a touch-panel. Display controller 663 includes electronic components required to generate a video signal that is sent to display 665.

Further, computing system 600 contains at least one network adapter 670 which is used to connect computing system 600 to communication network 310. Communications network 310 may provide computers with means of communicating and transferring software and information electronically. Additionally, communications network 310 may provide distributed processing, which involves several computers and the sharing of workloads or cooperative efforts in performing a task. It will be appreciated that the network connections shown are exemplary and other means of establishing a communications link between the computers may be used.

### Providing a Generic Gateway for Access to Protected Resources

As noted above, the computer described with respect to FIG. 1a can be deployed as part of a computer network. In general, the above description applies to both server computers and client computers deployed in a network environment. FIG. 1b illustrates an exemplary network environment, with one or more server computers (exemplified by servers 310a, 310b) in communication with client computers 320, 370b, 380, 370a via a communications network 300 and 350, in which the present invention may be employed.

As shown in FIG. 1b, a number of servers 310a, 310b, etc., are interconnected via a communications network 300 with a number of client computers 320 and other client computing devices that may be connected to network 300. Embodiments of the present invention allow clients connected to network 350, such as client computer 370a, 370b or 380 to obtain services from servers (e.g., servers 310a, 310b and/or from client computers acting as server computers such as 320) connected to network 300.

In some embodiments of the invention, the communications between clients on network 350 and servers or other computing devices on network 300 is facilitated by the collaboration between internal gateway 330 and external gateway 360. The operation of both internal gateway 330 and external gateway 360 is controlled by computing instructions manifested as software and/or firmware. The internal gateway 330 establishes a communication session via allowed ports and protocols of firewall 340 to metadata server 390. The metadata server 390 may authenticates internal gateway 330 using any means of secure authentication such as by using a shared secret, or by using a public key infrastructure mechanism such as X.509 certificates, or by other secure means of authentication, and verifies that the caller (gateway 330 or 360) is authorized to receive the metadata destined for it. The metadata held by metadata server 390 is defined and provided by an authorized user of the metadata service 390. The metadata service 390 may be exposed to designated/authorized end-users as a web service, web application that may use the web service or directly affect the metadata store, a combination of the two, or by other means of populating the metadata store, such as by using a rich-client application, client-server application, or any innovative means of populating the metadata store. Other means may include, but are not limited to sending data to the metadata service via email or FTP (in the form of an XML or other document format). In alternate embodiments of the invention, the metadata may be stored on the external gateway 360, internal gateway 330, another computing device on the internal network 300, the external network 350, or a combination of the above. The metadata may be stored as plain text, XML, database records, a combination thereof, or any other data representation format that may be appropriate. In addition, the metadata may be encrypted, and it may contain a hash value and/or a digital signature to protect against unauthorized tampering or improper use.

Once the internal gateway 330 receives its metadata from metadata server 390 which specifies to the internal gateway 330 the intended mode of operation for the particular instance of internal gateway 330, the internal gateway 330 is ready to initiate a connection to the external gateway 360. The metadata may include, but is not limited to: a list of internal hosts to expose, what ports and/or protocols on the specified internal hosts to expose, under which conditions such as time of day, day of month, etc., which external servers are to expose what internal endpoints, the level, type and strength of authentication required by external clients, specific network locations from which clients are allowed to invoke certain endpoint requests, the data pattern allowed from certain clients and to certain endpoints, the denial of service attack criteria for detection and protection, such as blocking a port after n failed attempts, the type of authentication required in order to communicate with external server 360, the location of the metadata service 390, the interval on which to query the metadata store 390, the timeouts of various types of connections, allowed ports on which to communicate to the metadata store 390 and to the external gateway 360, the types of encryption required for communication with the metadata store 390 or external gateway 360, the type of authentication required for communication with internal computing devices such as server 310a and 310b or client (acting as a server, or peer to peer) 320. Additional metadata which may be specified within the metadata stored by metadata server 390 consists of data transformation instructions to be performed by internal gateway 330 and/or external gateway 360, where to store access and change logs, where to obtain time information from, or any other data required for the proper operation of the subsystems comprising embodiments of the invention.

After the metadata is received by the internal gateway 330, the software or optionally, firmware controlling internal gateway 330 is responsible for establishing a secure persistent connection to external gateway 360 on which software or firmware is executing to control its operation. The connection is established using allowed ports and protocols as specified in the metadata. Typical ports and protocols are TCP/IP port 443 using the HTTPS (SSL) protocol. Other ports and protocols may be specified and used as described in the metadata for situations where port 443 or HTTPS are not allowed by the firewall 340, or are not desirable for other reasons such as availability of a better protocol, more secure protocol, faster, more modern protocol, etc. The connection is established and flows via firewall 340. Because the connection is initiated from within internal network 300 outward using ports and protocols allowed to flow through the firewall 340, connections are initiated from within the secured perimeter outward and the firewall 340 by default allows the data to flow freely and does not block the data communication as it would if the data communication were initiated from external network 350 into internal network 300.

The external gateway 360, in a similar fashion to internal gateway 330 is also controlled by software or firmware. The software, in addition to its other tasks and responsibilities, is responsible for querying the metadata store provided by metadata service 390 at a configurable interval. The software receives its mode of operation instructions from the metadata store 390 and it may persist it to its own data storage sub-system such as a hard disk or non-volatile memory or other data storage medium.

Upon receiving the pertinent metadata necessary for its operation, the software executing on the external gateway 360 opens the necessary communication ports and begins listening for requests on those ports. The ports and their behavior (protocol, throttling characteristics and other behavioral elements are controlled by the software in accordance with the received metadata from metadata server 390.

The software controlling external gateway 360 ensures that only the ports and protocols which are allowed to be utilized by the external gateway 360 are accessible and if an invalid or a malformed request is received by an open port, the request will not be honored and in addition may be logged to a data storage medium such as disk, non-volatile memory, database or another data storage medium or system and optionally may notify interested parties as indicated by the metadata stored by metadata service 390. Notification may be manifested as a web service call, email, SMS message, synthesized voice over telephone or Voice over IP, or by any other means of informing humans and/or machines of events of interest. Additionally, the metadata may contain information about behavior applicable to cases of suspected activity such as hacking or a denial of service attack attempts. The software, based on predefined rules manifested in the metadata or hard-coded into the software or firmware can block subsequent attempts to establish a connection from hosts that are identified as suspicious or malicious or not trusted for some reason. The software may store information about such suspected callers in a data structure that may be persisted to disk or other data storage medium. Data about the suspected clients may include, but is not limited to originating IP address, MAC Address, port number, browser type, segment information, cookie information, HTTP header information, frequency information, or any other pertinent information that may be used to correlate one suspicious call to a subsequent one.

Further, if the metadata specifies that only a certain host or set of hosts may gain access to certain endpoints, the software may enforce such a rule. For example, if URL https://bitkoo.com/companyZ/Service1 should only allow access to hosts residing on Internet addresses 162.22.12.10 through 162.22.12.55, if a request for this URL arrives from 162.22.12.34 it will be further inspected and potentially allowed to be fulfilled, but a request from 182.22.11.10 will be immediately refused and further processing may take place to log the event and optionally notify interested parties. In addition the Internet address from which the refused request originated may be blocked from further access to the external gateway 360 either permanently or for a specified period of time, as may be specified by the metadata stored on or made available by metadata serer 390. The suspected host may be blocked from accessing a certain port, protocol or any host or hosts. The level of blockage is specified by the metadata stored on or provided by metadata store 390.

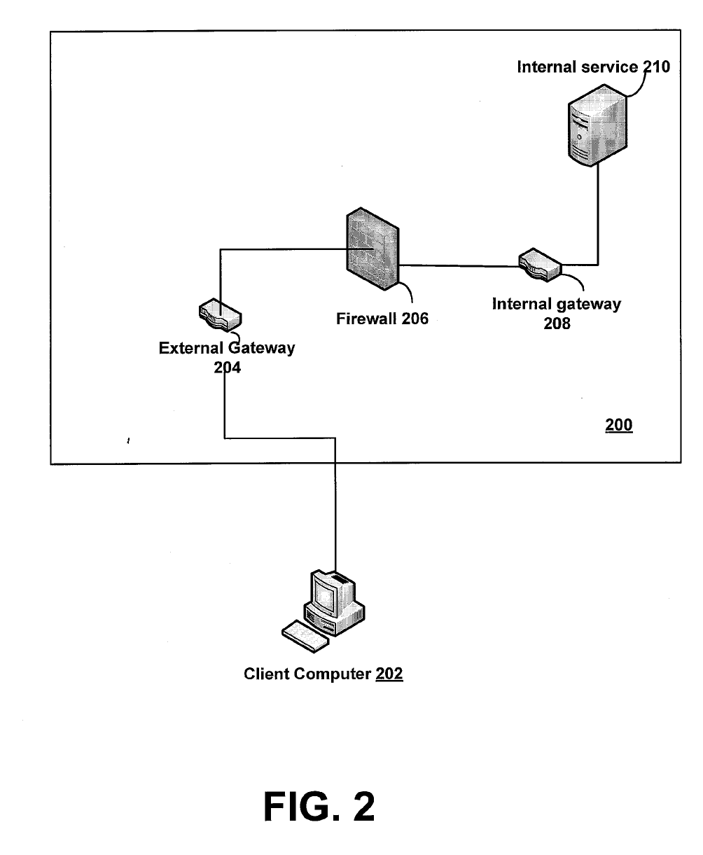

FIG. 2 illustrates an exemplary system 200 for providing a generic gateway for access to protected resources in accordance with embodiments of the invention. System 200 may reside in whole or in part on one or more computers such as the one illustrated above with respect to FIG. 1. One or more external entities such as client computer 202 may reside on or connect to an external network as described above. An internal network as described above may include one or more computing devices on which one or more internal services such as service 210, internal gateways such as internal gateway 208, and firewalls such as firewall 206 reside.

An internal service (represented by internal service 210 in FIG. 2) may be a web service, Telnet application, FTP or FTPS application, a web application, a MICROSOFT ACTIVE DIRECTORY-protected web service, MICROSOFT EXCHANGE SERVER, MICROSOFT ACTIVE DIRECTORY Domain Controller, a rich client application, a message-related system such as email, instant messaging or other data-transfer or computing-related application or any other network-addressable resource that would not otherwise be directly accessible to devices situated on an external network. In some embodiments of the invention, a web service internal resource complies with the SOAP (Simple Object Access Protocol) message format and is sent using the HTTP or HTTPS (a combination of a normal HTTP interaction over an encrypted Secure Sockets Layer (SSL) or Transport Layer Security (TLS) transport mechanism) transport mechanism, although the invention as contemplated is not limited to any particular message format standard or to any particular transport mechanism. Other examples include FTP service (File Transfer Protocol), SFTP (secure FTP), SMTP (Simple Mail Transfer Protocol), Telnet, Secure Telnet, Ping, ICQ, Microsoft Messenger, Skype, and any other type of network addressable endpoint. The list of protocols and ports which can be exposed using the generic internal/external gateway mechanism is not finite and thus can grow as new protocols and ports are utilized. As a matter of partial reference, there is an Internet accessible list of assigned port numbers that can be reviewed at the following URL: http://www.iana.org/assignments/port-numbers. The list includes protocols that can be exposed using various embodiments of the current invention but it will be understood that the invention as contemplated is not limited to these protocols and includes within its scope any suitable protocols now known or developed in the future.

An external gateway (represented by external gateway 204 in FIG. 2) may be a message router. It may reside on one or more computer devices in system 200. In some embodiments of the invention the external gateway is accessible to external clients such as client computer 202. As used herein an external client is one that resides on an external network or that accesses system 200 via an external network. A firewall (represented by firewall 206 in FIG. 2) may be any known or as yet non-existing software, hardware or combination thereof, which performs security functions limiting the exposure of a computer, resource or network to access from external entities. An internal gateway (represented by internal gateway 208 in FIG. 2) is another message router.

System 200 may also include a datastore (not shown) and software to process the data stored in the datastore. The datastore in some embodiments includes information concerning the internal resources that can be exposed to external clients. The datastore, also referred to herein as the metadata store acts as a system of record for data which is required by the various software elements of system 200. The metadata store may be comprised of a database or a plurality of databases, web service or plurality of web services. In addition the metadata store may include user interface components such as a web application accessible to authorized users, so they may insert, modify or delete metadata pertaining to the expected operation of the various elements of system 200.

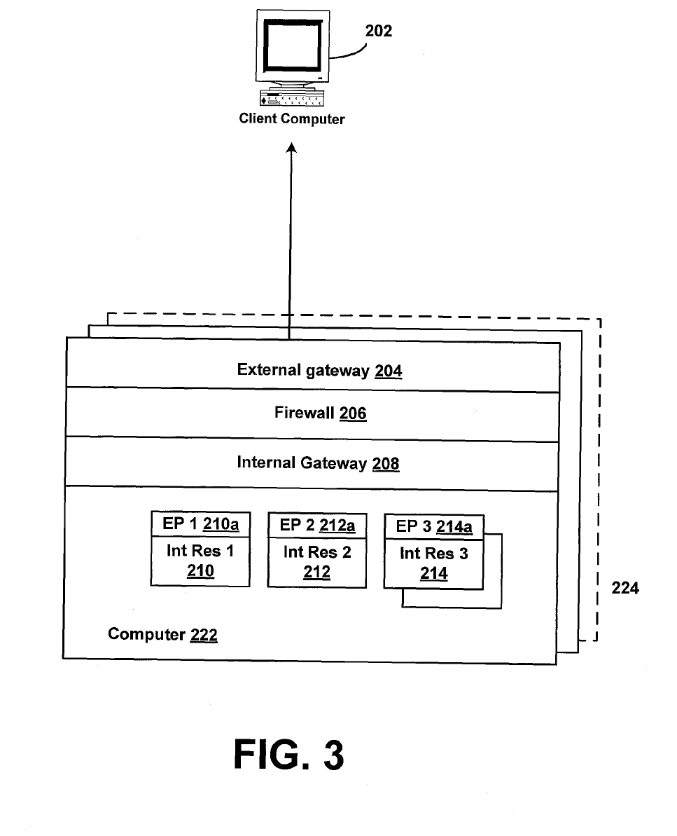

FIG. 3 is another block diagram of a system for providing a generic gateway for access to protected resources in accordance with some embodiments of the invention. In FIG. 3 one or more external entities such as client computer 202 may reside on or connect to an external network as described above. A private protected network may include one or more computing devices such as computer 222, 224, etc. Each computer 222, 224, etc. may include any combination of the following: an external gateway (e.g. external gateway 204 on computer 222 in FIG. 3), a firewall (e.g., firewall 206 on computer 222), an internal gateway (e.g., internal gateway 208 on computer 222) and a datastore 216 and associated software (the metadata store) (not shown). Alternatively, all the computers in the private network 216 may communicate with the external network 218 via a single external gateway located on one computer (not shown) or via several external gateways located on other computers. Similarly, a single firewall/internal gateway/datastore located on a single device may serve all the computers in the internal network or several firewalls/internal gateways/datastores may reside on several devices serving all or some portion of the computers of the protected network. Internal resources such as internal resource 1 210, internal resource 2 212 and internal resource 3 214 may represent any network-addressable resource as described above. Endpoints such as endpoint 1 210a for internal resource 1 210, endpoint 2 212a for internal resource 1 212 and endpoint 3 214a for internal resource 3 214 in FIG. 3 may represent an HTTP-based endpoint for an application, a TCP/IP or UDP port of a private network, or a WINDOWS Communications Foundation (WCF) endpoint.

In operation, in some embodiments of the invention, a user on the protected network or on the external network may log on to an administrative application to specify a location of an internal computing resource to be exposed. The location may be any addressable network location or application endpoint and may be specified by URL, TCP/IP or UDP address, port number and/or URI, or by other network location technology not yet known or available. A protocol to be used to access the resource may also be specified. The server or servers (e.g., on the external network) to which the resource is to be exposed may also be specified. A security policy to be enforced for the resource may also be specified. Some or all of the specified metadata described above may be stored in a datastore (in the metadata store). It will be appreciated that the user (e.g. system administrator) need not be a network engineer or proficient in network technology.

The metadata store software automatically (without additional user direction) provisions the various elements including ports, gateways, etc. necessary to enable one or more external clients to access the protected resource via designated gateways. Further, the gateways provide authentication information that enables the metadata store to determine whether they should receive data and which data subset to return to them. The devices making use of the metadata store initiate a communication session to the metadata store. The address of the metadata store may be obtained from a configuration record on the calling device, or may be obtained from a well known network accessible location whose responsibility is to notify devices of the network addressable location of the metadata store. Devices utilizing the metadata store may be required to authenticate to the metadata store to prevent impersonation of devices and to prevent unauthorized retrieval of metadata information that could be considered confidential. The authentication may be accomplished using X.509 certificates, user id and password, or other authentication technology as is appropriate for the type of data being communicated and as may be dictated by the organization's security policy. The metadata store software examines the interface to the internal resource and, utilizing standard ports and protocols which are allowed to be initiated from the internal network to the outside network, provides this information to the external gateway, which is deployed outside of the firewall or similar physical or logical barrier.

The external gateway may use this information to expose a seemingly identical interface outside the firewall on the external gateway to external clients. When a request is received on the exposed interface of the external gateway, the gateway may place the request in a queue. The queue may be implemented as an in-memory data structure or as a persistent data structure such as a file disk, message queue, database record, etc. The external interface may then refuse to accept more requests until the response to the request is provided by the gateway deployed on the internal network (i.e., by the internal gateway). Alternatively, requests may be queued up until sent on to the internal gateway, while continuing to service incoming client requests and to process all requests asynchronously and simultaneously. Multiple threads, processes and a multi-processor computing device may be utilized.

The internal gateway may continuously poll the external gateway for queued messages over an already established and persistent HTTPS session or it may poll the external gateway using new stateless connections that are established on an as-needed basis. In cases where a firewall or similar device prohibits the usage of HTTPS, the collaborating gateways (internal and external) may use alternative ports and protocols with optional encryption. Once a request is available in the queue or similar data structure/mechanism, it is sent in response to the polling or listening operation initiated by the internal gateway. The internal gateway routes or replays the message to the corresponding internal resource. In an optional step, the internal gateway may transform the request in order to accommodate the data format expected by the internal endpoint. The internal gateway waits for a response from the internal resource. When the response is received, it is sent to the external gateway. In an optional step, the response may be transformed to a different data format to accommodate the data format acceptable to the external client. The external gateway sends the response on to the external requester after correlating it to the correct request using an internal assigned handle or other means to correspond response to request. In some embodiments of the invention, the system may modify URL references included in the response received from the internal resource so that the URL references point to the external gateway instead of to the internal endpoint. When a request is initiated from the external gateway which includes these modified URLs, the URLs may be translated to internal endpoint URL references. In some embodiments of the invention, the gateways (either internal or external or both) may log message data for various reasons as may be specified by a system administrator and notated in the metadata store. The message logs may include, but are not limited to any combination of the following pieces of information: the entire message from client to server, the entire message from server to client, message time, source, destination, type, size, authentication and authorization type. The message may also indicate that the request is unauthorized and list request time, source, destination, full message, size and so on.

Hence, to the external client, it is not apparent that the entity the client is accessing (i.e., the external gateway) is a proxy for the actual internal resource and that communication with the internal resource is actually being initiated from within the protected network. To the external client, it appears that the entity the client is accessing (i.e., the external gateway) is the actual internal resource. Thus any SOAP-based web service or other network-addressable protected resource deployed on a first private network may be exposed to a second private or public network while using existing firewall configuration securely (e.g. without changing organizational security policies and without changing the firewall to allow specified incoming traffic from an external network through the firewall).

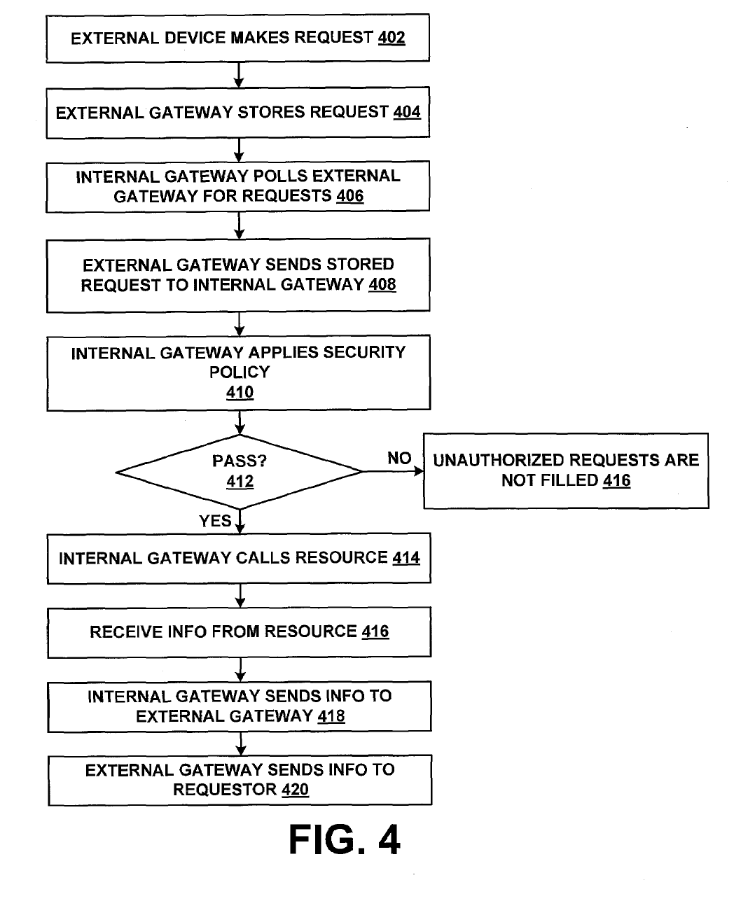

FIG. 4 illustrates an exemplary method for providing a generic gateway for accessing protected resources in accordance with some embodiments of the invention. At 402 an external device such as computer 202 of FIG. 2 may send a request to access a protected resource such as resource 210, 212, 214, etc of a private network. Although the external device is attempting to access the protected resource, an external gateway such as external gateway 204 actually receives the request. To the external device the external gateway appears to be the internal resource. At 404 the external gateway receives the request, and logs or stores the request in temporary or persistent storage. Requests may be queued up until requested by software in the internal gateway that manages the requests stored by the external gateway. At 406, the internal gateway requests the external gateway for any incoming requests for service. In some embodiments of the invention, the internal gateway establishes a connection to the external gateway using port 80 using clear text or encrypted communications over HTTP or port 443 and the HTTPS protocol. In other embodiments of the invention other communication protocols and ports may be utilized. The internal gateway may keep an open connection to the external gateway and poll or query periodically for any pending requests. At 408, the external gateway sends the internal gateway the stored request. When a request is available, the request may be received over the already established HTTP or HTTPS session or another alternative communications protocol. At 410, the internal gateway applies the specified security policy for that type of request for the resource requested. The security policy may be defined by using a metadata store system which may include a set of web services, web applications, databases, etc. The internal gateway software maps the requests received from the external gateway to the appropriate internal endpoints. The internal gateway calls the appropriate resource, the call looking essentially identical to the call received by the external gateway from the requester at 404. In an alternative embodiment, the data sent from the internal gateway to the internal resource may be transformed in order to bridge two different protocols or message formats, or for other reasons, by the software residing on the internal gateway based on metadata stored in the metadata store or based on hard coded instructions residing in software or firmware. The transformation may consist of simple XSLT-type transformation or any other type of transformation which can be described as a set of instructions and be executed by software and/or firmware using a computing device. At 412, the request is evaluated with respect to the security rules. If the request is authorized, processing continues at 414. If the request is determined to be unauthorized, the request is not filled and a suitable message may be returned to the external gateway. The external gateway then may determine whether to block the caller, return an error message to the caller, inform an operator via email, SMS, web service or other communications mechanism, etc. At 414, if the request is determined to be authorized, the internal gateway accesses the resource corresponding to the endpoint requested of the external gateway. At 416, the information requested is produced by the internal resource and is sent from the resource to the internal gateway. The internal gateway forwards the information over the already established connection from the resource to the external gateway at 418. At 420 the external gateway correlates the received information with the appropriate requestor and forwards the information to that requester.

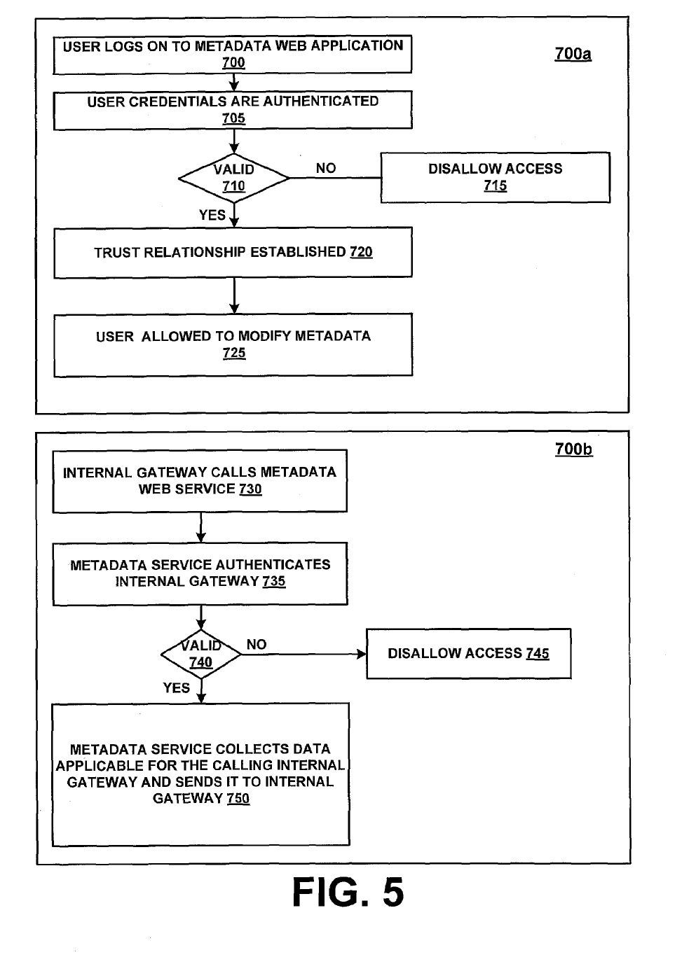

FIG. 5. illustrates another method for providing a generic gateway for accessing protected resources in accordance with some embodiments of the invention. In 700a, an exemplary method of modifying the metadata is shown. Specifically, 700a depicts a mechanism for governing the metadata store by authorized users. At 700, a user who is designated by an organization as administrator of the system for exposing internal resources to the external network may utilize a web application which presents him/her with a logon screen. The logon screen is presented as a response to the user taking the action of typing in a URL in the web browser address bar, or clicking a shortcut. The URL is the web location of the metadata administration application. At 705, once the user has provided his or her credentials which may consist of a user name and password, or other information such as a user designated domain, user name and password or other combination of user credentials, the application may encode the credentials and sends the data to a web service deployed on the same host or a different host. The web service performs authentication and authorization to ensure that the user is who he/she claims to be and to ensure that the act of administrating the system is permitted. At 710, the application branches as a result of a comparison as to whether or not the authentication and authorization yielded a positive or negative result. If the validity of the credentials provided is not established, the application may disallow the user further access, as shown in 715. Also in 715, the application may log the unauthorized failed attempt to access the application and optionally notify humans or computing agents that a failed attempt has occurred. The notification may be carried out via a plurality of notification mechanisms such as SMS message, email, web service invocation, synthesized voice over a telephone or other communications device, etc. At 720, assuming that the validation of step 710 succeeded, the web application which is responsible for rendering HTML or other display rendering mechanism, communicates with a backend web service. It may establish an HTTPS session with the web service and provides authentication data identifying the user. A security token returned from the web service to the web application over SSL may be used for subsequent calls to ensure that the web service is not abused. Alternatively, a variety of other techniques known in the art of secure communications between a web application and a web service may be used, as the technologies and techniques used in the establishment of secure communications between the web application and the web service may change over time and best practices may dictate accordingly. At 725, once the administrative web application determines that the user is permitted to modify the metadata or a subset of the metadata, it may allow the user to modify the metadata and it may interact with the web service that in turn may persist any modification by the user of the metadata to a persistent storage medium such as a disk file or a database.

In FIG. 5, 700b illustrates an exemplary method for providing applicable metadata to the collaborating gateways (internal and external) in accordance with some embodiments of the invention. The metadata may contain, among other things the gateway's operating instructions or marching orders. These instructions govern what ports to make available on the external gateway, to which clients to allow or disallow access, what sort of translation should occur between external and internal endpoints, which internal endpoints map to what external ports and protocols, what authentication and authorization mechanisms to employ on each external and internal endpoint, what users to notify and by which channel and of what events, and any other metadata necessary for the successful deployment of the generic gateway system for accessing internal endpoints. At 730 the internal gateway may initiate communications over SSL or similar facility in order to obtain the metadata applicable to the particular internal gateway. The internal gateway may retrieve authentication credentials from its own persistent storage. The credentials may include an X.509 certificate, another asymmetrical key or a symmetrical key, or another yet to be discovered system-to-system authentication scheme.

At 735 the metadata service may authenticate and authorize the calling gateway (internal is shown at 730, but it is applicable to external gateway as well). If the credentials provided by the calling gateway pass the scrutiny of the metadata service, the metadata service may query its own persistent storage (such as a database) for a subset of the data that applies to the calling gateway. The metadata service then may serialize the data in the form of an XML document or similar construct and may return the XML document or similar construct back to the calling gateway over the SSL or similar communications channel. In an optional step the metadata service may digitally sign the XML data or other such construct in order to avoid the possibility of tampering on the gateway's persistent storage representation of the metadata.

At 740 and 750 if the gateway (internal or external) passes all authentication and authorization checks, the metadata service may query its data storage subsystem (database) for data that is applicable to the calling gateway. The applicable data may then be serialized in the form of an XML document and optionally (based on configuration parameters) digitally signed, then the data is sent from the metadata service back to the gateway. If authentication and/or authorization fails, at 745 a process may log the disallowed request for metadata, storing all possible data points necessary to further investigate the attempt. The data points may include, but are not limited to IP address of client, MAC address if available, date, time, data provided in the request, number of attempts, etc. Additionally, failed requests may cause blocking of the calling network client from subsequent calls, either permanently, or for a configurable amount of time. Also in 745, suspected requests for metadata may precipitate notification to authorized subscribers. Notification may occur over a variety of notification channels such as SMS, Email, web service calls, etc.

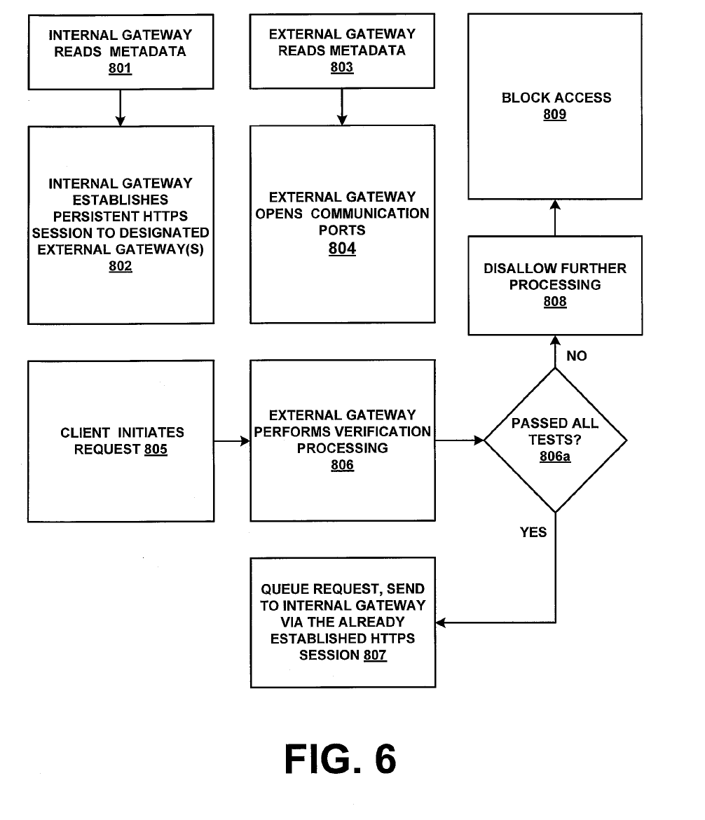

FIG. 6 illustrates further aspects of providing a generic gateway for accessing protected resources in accordance with some embodiments of the invention. At 801 the internal gateway may receive the metadata from the metadata service in the form of an XML document which can be digitally signed to prevent with tampering with the data after it has been stored in the persistent storage of the internal gateway. The metadata provided by the metadata service to the internal gateway can provide the internal gateway with enough information about what external gateways to reach out to, what internal endpoints to make available, what translation, if any is necessary from the format of externally provided input and input to internal endpoints and the translation, if needed, from output from the internal endpoint to the external client, under what conditions to allow communications to internal endpoints, from which external endpoints and other such information as to allow the internal gateway to securely expose internal endpoints to the external gateway. Once the metadata is received as shown in 801, the internal gateway may validate the digital signature of the metadata. The metadata received by the internal gateway in 801 can be considered as the “marching orders”, or detailed to-do/allowed list for the internal gateway. At 802, the internal gateway performs actions as instructed by the received metadata. The internal gateway may establish a persistent HTTPS session to the external gateway or gateways specified by the metadata received. It should be appreciated that an alternative persistent communication mechanism can be substituted for the HTTPS connection and the determination as to what communication mechanism to use may be specified by the metadata. Reasons for using an alternative include the following: the firewall blocks port 443 (typically used for HTTPS), or a newer, better communication option is made available, or for any other reason. A persistent connection can be established by the server component of the client/server relationship returning an HTTP/S protocol header specifying the content size as a very large number. In one possible embodiment, the large number is the maximum value possible for a long integer (64 bit). Given this large value, the connection will remain open for a prolonged period of time. When the connection is closed for any reason, it is the responsibility of the client to re-establish connection.

It should be appreciated that at 802, because communications are initiated and established from the internal gateway to an external gateway, communication is allowed to flow unhindered by the physical or logical barrier protecting the internal resources. This assumes that data can travel from the internal network to the external network. Further in 802, it is possible that the internal gateway is initialized before the external gateway. This possibility may mean that when the internal gateway attempts to establish a persistent connection to the external gateway, the external gateway is not yet ready to receive requests from the internal gateway. This may be due to not yet receiving the metadata and thus not opening the port necessary for accepting requests from internal gateways. In addition to not opening the port(s), the external gateway may also not have the authentication and authorization rules by which to make services available to the internal gateway and hence refuse connection. To accommodate that scenario, the internal gateway may employ a mechanism whereby it delays calling the metadata service for the first time and in addition, when a connection is refused from the metadata service, it may wait for a configurable amount of time and then try again. It may do so continuously until successful, or until a max tryout value is reached. The maximum tryout value can be provided as a configurable parameter.

At 803 and 804 the external gateway receives its “marching orders” from the metadata service. As a result of securely receiving this information and optionally persisting this information to its persistent storage, the external gateway processes its instructions in accordance with the metadata. It opens the appropriate ports and listens for client requests as shown in 804. In 804 all necessary initialization steps are taken by the external gateway. These initialization steps include opening up ports that listen for connection requests from internal clients and opening up ports that listen for client requests. In addition, previously opened ports may be closed or blocked as a result of a change to the metadata applicable for the external gateway at hand.

At 805 a client situated on a network external to internal endpoints such that the client would under normal circumstances be prevented from accessing internal endpoints by a physical or logical barrier such as a firewall implemented either in hardware, software or a combination thereof, initiates a request over the network which can freely access the external gateway. The client may be any computing device such as a personal computer, server computer, wireless hand help PDA, hand-held network enabled phone, or any other network capable device. The format of the message initiated from the client device may be identical to the format expected by the servicing internal endpoint, or the format, protocol and encoding may be different. The external gateway in 806 may inspect the request from the client device and can determine whether or not to allow the request to continue being processed, or to block further processing.

At 806a the external gateway branches, depending on the validity of the client request and its passing the validation rules specified by the metadata delivered to the external gateway from metadata server. In the case that the request is valid, the request may be queued in memory and as soon as processing can proceed, the request is serialized and sent to the internal gateway over the persistent and already established communication session which was initiated by the internal gateway to the external gateway. If the request is not valid, in 808 and 809 the external gateway disallows further processing and optionally logs, blocks and notifies interested parties. The actions that are performed upon an unauthorized request may be variable and dependant on the metadata, or they may be hard coded in the software or firmware. At 807 the request, whether in original format or after a possible transformation performed by the external gateway is sent to the internal gateway, over the already established persistent communication session from the internal gateway to the external gateway.

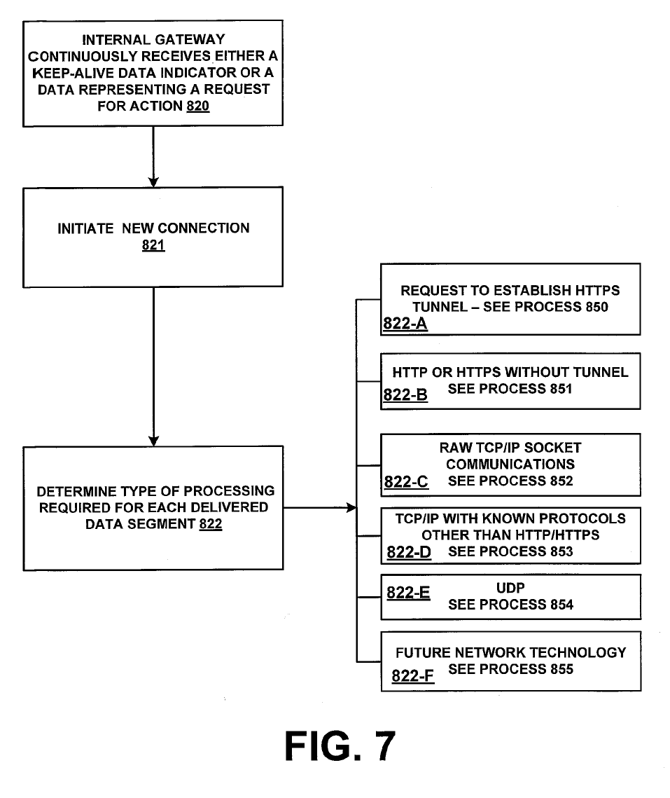

FIG. 7 illustrates an exemplary method of aspects of providing a generic gateway for accessing protected resources in accordance with some embodiments of the invention. At 820 the internal gateway having initiated at an earlier point in time a persistent connection via HTTPS or alternative protocol to the external gateway, via an existing physical or logical barrier such as a firewall which restricts network traffic so that traffic is only allowed to pass if the protocol and ports are allowed and if initiated from within the protected network outward to the external network. Assuming a typical scenario, although alternative embodiments may utilize ports other than 443 and protocols other than HTTPS as may be dictated by the firewall configuration, the firewall allows connections to be initiated from within the internal network outward over port 443 utilizing the HTTPS protocol. Once the internal gateway successfully connects to the external gateway, the external gateway may send back a response with a content size of Long.max( ). Long.max is a value consisting of 64 bits, having all the bits set to 1. Of course, other large content size values may be utilized. Since Long.max is an extremely large number, the server, for practical purposes will continuously transmit data to the client, and the client (in this case the internal gateway) will continuously receive data on the established HTTPS session. The external gateway may send on a periodic basis configurable as defined by a metadata parameter, a keep-alive or “heartbeat” data stream to the internal gateway. The purpose of the keep-alive data stream is to keep the socket connection open by the TCP/IP stack on both ends of the communication channel. If no data is transmitted while no external clients request data, then without the keep-alive periodic transmission the timeout internal will be reached and the TCP/IP stack will cause the connection to be closed. Using the keep-alive/“heartbeat” the gateways can maintain a president connection. Other techniques to keep the communications open may be utilized and it should be understood that the method described above is merely one embodiment, but not the sole one.

At 821, the internal gateway keeps track of the keep-alive data transmissions and records in-memory the time of the last keep-alive received. If the application layer within the external gateway is not responding for any reason, even though the lower level, transport layer is still connected, the internal gateway may initiate a new connection and close the apparently nonresponsive connection.

At 822 the internal gateway which receives requests for action from external gateway over the persistent connection established earlier from the internal gateway to the external gateway, evaluates the requests by parsing the stream of data being sent by the external gateway. Various types of requests may be generated by the external gateway, depending on the type of service to be delivered by the internal/external gateway pair as determined by the metadata and the capabilities of the internal/external gateway pair. The services include, but are not limited to: straight tunneling of TCP or UDP packets from client to internal endpoint without translation; value-added (transformation and data-inspection enabled) tunneling of TCP or UDP packets whereby the external and internal gateway can each perform translations based on metadata to adapt input by a client to a different format and/or protocol of the endpoint and to adapt an output from an endpoint to a format and/or protocol acceptable to the requesting external client; queued request response, with or without protocol and/or format translation whereby a request is placed in a queue of the external gateway until it is sent when possible to the internal gateway over the persistent connection established by the internal gateway. When the queued request arrives at the internal gateway, depending on the associated metadata, the request may be translated/transformed in accordance with metadata concerning a needed transformation, or passed as-is without additional value added by the internal gateway to the internal endpoint where it is being processed by the internal endpoint. The internal gateway may perform various security related checks to ensure that the data sent from external gateway is allowed to proceed. Upon response from the internal endpoint, the internal gateway may apply a transformation to adapt the output to a format and/or protocol acceptable by the requesting client and finally, deliver the response back to the external gateway, which in turn return the transformed or straight (as-is) response back to the external client.

Branching out of 822 are various types of external gateway to internal gateway processing action requests. The action, as mentioned above is determined by the external gateway based on metadata. The external gateway encodes the desired action as part of the message stream sent to the internal gateway and after the internal gateway parses the request, it collaborates with the external gateway for the purpose of processing the request in the most efficient and secure manner. In 822-A the external gateway encodes a string of characters to denote it requests a tunnel from the internal gateway. This is a point-to-point connection of the sockets on both ends of the communication system. The generic gateway system is responsible for connecting the external gateway socket communicating with the external client to the socket exposed by the internal endpoint which services the request of the external client. In this mode of operation, the gateway system may or may not have the means to inspect the data being transmitted from client to server endpoint. In the case of encrypted communications such as communications using the HTTPS protocol, the gateway system may connect the two endpoints (external client and internal endpoint) but be unable to decipher the content of the data being transmitted because it is encrypted/decrypted by the client and the server. In the case that the communication protocol being utilized is not encrypted by the endpoints, such as in the case of using the HTTP, FTP, SMTP, TELNET, and similar such non-endpoint-encrypted protocols, the gateway system may inspect, log, block, route, throttle, transform, alert users, learn (for the purpose of distinguishing correct patterns from incorrect ones), and other computing operations related to the data being transmitted on the established tunnel between external client and internal endpoint.

At 822-B the external gateway encodes in a string of characters being sent to the internal gateway over the established persistent communication channel between internal and external gateways an indication that a non-tunnel HTTP or HTTPS request is forthcoming and should be handled/processed by the internal gateway. In this mode of operation, the internal gateway receives the request sent by the external client, either as-is, or optionally after a transformation step performed by the external gateway. It may apply its own transformation, authorization, authentication, logging, blocking, alerting, learning (to distinguish between valid and invalid requests) and any other computation necessary in order to process the external client request. It is important to note that this method is different than the process described in 822-A in that in 822-A a tunnel was established and in 822-B no tunnel is being utilized but rather a queue or similar mechanism is employed to store and forward the request and then after processing occurs by the internal gateway and the internal endpoints, queuing or similar mechanism is employed in a store and forward fashion to return the response to the external client.

At 822-C the external gateway encodes a string of characters sent to the internal gateway over the established communication channel from internal to external gateway indicating that the request consists of a request for tunnel over a newly established or optionally via an existing persistent secure socket to socket channel, such as, but not limited to HTTPS. Under this process, the external gateway informs the internal gateway that a server socket on the external gateway needs to connect to a client socket on the internal gateway. The internal gateway socket which the internal gateway instantiates and initializes connects to the ultimate internal endpoint as specified by metadata of the internal gateway, and the internal gateway connects the two transmission sockets to form a persistent tunnel.

At 822-D the external gateway encodes in a string of characters sent to the internal gateway over the established communication channel from internal to external gateway indicating that the request consists of a non-HTTP/HTTPS request but over TCP and that the protocol is well known to the gateway system. By well known it is meant that the gateway system has sufficient computing instructions to make a determination of how to connect the external client to the internal endpoint. Whether to use tunneling or request/response queuing, or a combination of the two. Depending on the protocol, the gateway system may utilize computing instructions to add authentication, authorization, data inspection, data validity checks, data learning, logging, notification, transformation, blocking, throttling, and any other data manipulation as may be determined in the metadata.

At 822-E the external gateway encodes in a string of characters sent to the internal gateway over the established communication channel from internal to external gateway indicating that the request consists of a UDP request. Further, the encoded string may indicate whether the UDP request is understood (i.e., uses a well known protocol such as DNS) or not understood (i.e., is proprietary or not yet included in the gateway system instructions). The gateway system comprised of the internal and external gateway, in collaboration with the metadata store, may make a determination of how to enable communication between external client and internal endpoint. Depending on protocol higher than the UDP, it may be determined that a tunnel should be used, or it may be determined that a request/response queue or similar mechanism should be used. In either scenario, tunnel or queue, the gateway system may log, block, throttle, transform, authenticate, authorize, notify and any other computing operation indicated by metadata in connection with the data being requested and sent from either side of the communication channel.

At 822-F the external gateway encodes in a string of characters the type of request being requested by the external client. The system is able to handle future networking technologies and protocols. This is facilitated by a dynamic design which can be implemented by decoupling the system into a system of collaborating and dynamically loaded dynamic linked libraries. These libraries are not constrained to a single computing platform or operating system and may be implemented on any computing device and any operating system. Both gateways may receive their computing instructions from third party servers such as the metadata server, or another server whose location and other attributes are provided by the metadata server. As new communication technologies and protocols become available, computing instructions that instruct the internal and external gateways how to bridge the external client to the internal endpoint may be stored by the metadata server or other subsystem server and the software or firmware executing the programs making up external and internal gateway can load the instructions which are dynamically loaded and bridge the connection accordingly.

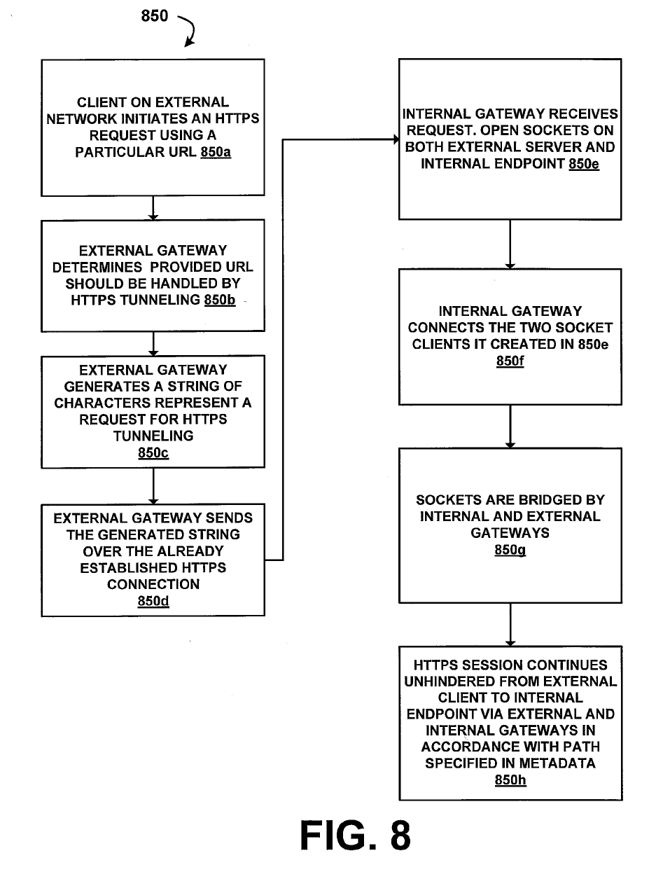

FIG. 8 illustrates aspects of a method for providing a generic gateway for accessing protected resources in accordance with some embodiments of the invention. FIG. 8 illustrates embodiments of the invention in which the internal gateway determines that an HTTPS tunnel is to be established (process 850). At 850a, a client on an external network may initiate an HTTPS request to the external gateway using a particular URL. A proxy situated on the client or on a client network may forward the request to the external gateway. The proxy may translate a request for a particular URL to a URL exposed by the external gateway. At 850b the external gateway may determine based on the URL header within the request that the provided URL should be handles by HTTPS tunneling (as opposed to request/response processing). At 850c, the external gateway may generate a string of characters agreed upon in the shared protocol with the internal gateway to represent a request for HTTPS tunneling. At 850d the external gateway may send the generated string representing the type of request over the already established HTTPS connection initiated by the internal gateway. At 850e the internal gateway may receive and parse the request over the established communication session and simultaneously open a client socket using HTTPS to both the external server and the internal endpoint specified in the metadata to correspond to the provided URL. At 850f the internal gateway may connect the two socket clients it created in 850e, providing coupling and hence facilitating data flow between the external gateway and the internal endpoint. At 850g the external gateway having a socket connection open and connected to the external client managed by a thread, is coupled to the server socket managed by a second thread. This server socket may be opened as a result of 850f above initiated by the internal gateway. At 850h, the HTTPS session may continue unhindered from the external client to the internal endpoint via external and internal gateways in accordance with the path as specified in the metadata.

Depending on the type of protocol used by the external client and the internal endpoint, various types of processing by the internal and external gateways are possible. For example, if the system administrator having access to the metadata service determined that the external gateway should be the SSL endpoint and that a second SSL connection will be established from the internal gateway to the internal endpoint, then the external endpoint will expose an HTTPS URL and will accept the external client's request. After the request has been received it is available in clear text to the external gateway. It can then apply security checks, transformations, logging, add security tokens, etc. If, however, the system administrator specified that the connection from the external client to the internal endpoint will be conducted through a tunneled HTTPS connection then the internal and external gateways perform a collaboration as defined elsewhere so that no intermediate points in the system may inspect the contents of the data and the data is flowing through a traditional SSL session.

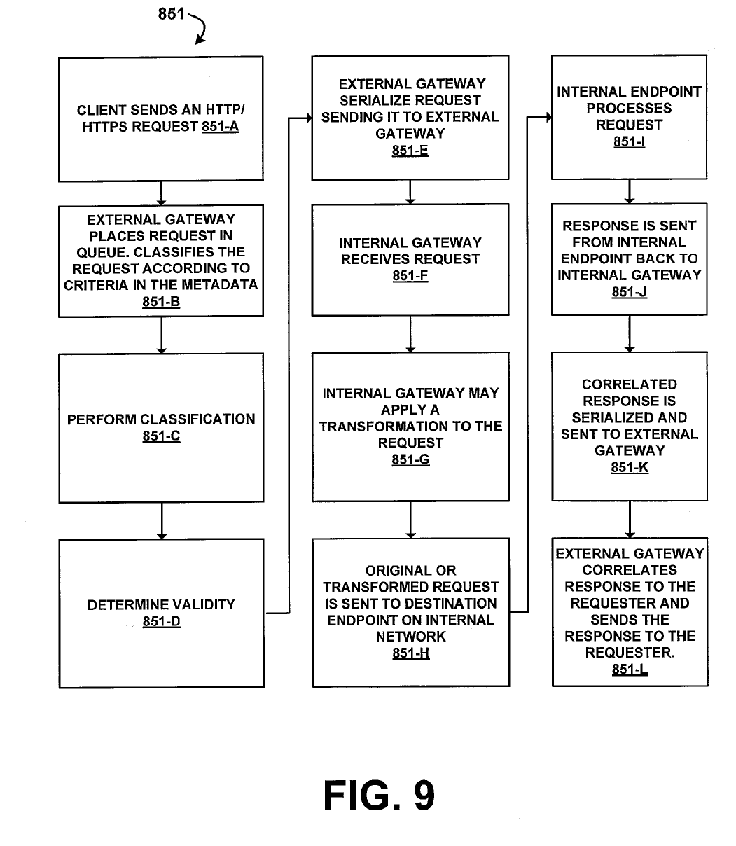

FIG. 9 illustrates aspects of a method for providing a generic gateway for accessing protected resources in accordance with some embodiments of the invention. FIG. 9 illustrates embodiments of the invention in which the internal gateway determines that an HTTP or HTTPS connection without a tunnel is to be established (process 851). At 851-A a client on an external network may send an HTTP or HTTPS request with the host name portion specifying that of the external gateway. The request may include additional path information that identifies the ultimate internal endpoint. At 851-B the external gateway may place the entire request in an in-memory queue or other queuing mechanism or data structure, whether in-memory or persistent storage. It may then classify the request according to criteria in the metadata held in memory or on other data storage medium. At 851-C, classification may be performed based on path data, header data, body data, origin of request, time of day, date and authentication data or other data that may be gathered from the request. At 851-D, if the request is determined invalid based on metadata, (for example, if the path requested is not registered in the metadata or the data length for a given path is incorrect, or authentication information is missing or incorrect), further processing may be disallowed and the information logged. Interested parties may be notified and the requested endpoint may be blocked to that requester. At 851-E, a process on the external gateway may remove the request from the in-memory queue and serialize it via the already established HTTPS session initiated by the internal gateway. At 851-F, the internal gateway may receive the request encapsulated in an agreed-upon delimiting string on the already established HTTPS or similar session and place the de-serialized representation of the request in its own in-memory or other data storage medium queue or similar data structure. At 851-G, a separate thread or process on the internal gateway may remove the request from the queue and depending on the metadata definition for the endpoint associated with the request, may transform the request using transformation instructions provided in the associated metadata. At 851-H the original or transformed request may be sent to the destination endpoint on the internal network as specified by the correlation of the path information and a look up in the metadata. At 851-I the internal endpoint may process the request. At 851-J the response may be sent from the internal endpoint back to internal gateway which correlates the response to the request. At 851-K, the correlated response may be serialized and sent to external gateway on the already established HTTPS or similar session. At 851-L the external gateway may receive the response, correlate it to the requester and send the response to the external client requester. The response may be transformed in accordance with the associated metadata instructions. Further, the response may be logged, trigger notification, throttled, authenticated, authorized (determined to be appropriate for the requester), transformed, augmented (data added as a result of computation or data lookup), and any number of other computational operations performed by the gateway system on the response applied.

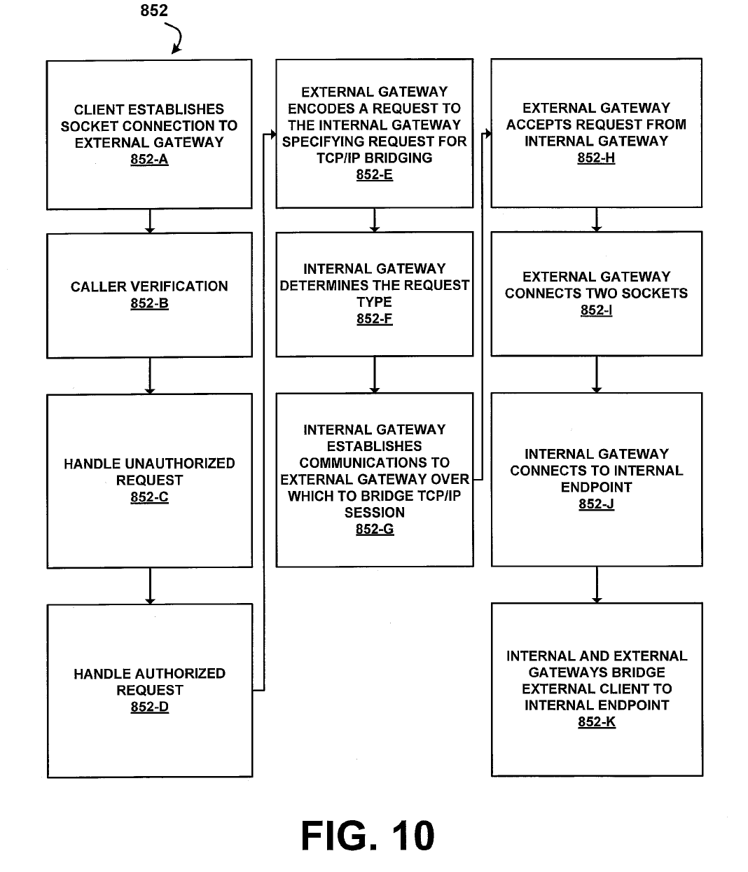

FIG. 10 illustrates aspects of a method for providing a generic gateway for accessing protected resources in accordance with some embodiments of the invention. FIG. 10 illustrates embodiments of the invention in which the internal gateway determines that a raw TCP/IP sockets communication is to be established (process 852). At 852-A a client application may open a socket connection to the external gateway which has an open server socket listening for requests based on data specified in the associated metadata. The port number may be specified in the metadata and accordingly the specified port number may be opened. At 852-B the external gateway may check the in-memory metadata that was optionally previously loaded to determine if a TCP/IP connection on the given port is authorized to initiate from the client's network address. At 852-C if the network address of the client is not authorized, further processing may be prohibited and the caller connection may be disconnected. The information may be logged and interested parties notified and/or the particular client may be blocked from further processing, either permanently or for a configurable period of time. At 852-D if the connection request is determined to be from a network address permitted to initiate a connection, a request for TCP/IP tunnel may be placed in a memory queue or similar data structure, specifying the endpoint information requested as properties of the data structure being stored in the queue. At 852-E a thread or similar construct such as a process or app domain on external gateway may remove the request for a TCP/IP tunnel from the queue (or similar data structure) and may encode a request on the already established communication session with the internal gateway (initiated by the internal gateway) to request TCP/IP bridging. The encoding may include metadata and delimiting data agreed upon in the protocol shared by the internal and external gateways.

At 852-F internal gateway parses the data stream that was transmitted from external gateway and determines that a request for TCP/IP bridging is pending. The data stream is the one that was previously established and initiated by the internal gateway to the external gateway.

At 852-G the internal gateway establishes a new HTTPS or similar communication session with external gateway over which to conduct the TCP/IP bridging. The external gateway prior to sending the request for bridging to the internal gateway already opened a server socket listening for such HTTPS or similar requests and the external gateway may authenticate and authorize the resulting call back from the internal gateway to establish the TCP/IP bridging operation.

At 852-H the external gateway may authenticate and authorize the request for persistent connection initiated by the internal gateway (as a result of a request initiated by the external gateway to the internal gateway sent over the persistent already established connection). Upon successful validation of the request, the external gateway allows the internal gateway to receive a persistent connection. Keep-alive or heartbeat may optionally be generated by the external gateway in order to maintain the connection persistent without it disconnecting unexpectedly.

At 852-I the external gateway internally connects the two threads—one in which the server socket faces the external caller and the second in which communication is handled with the internal gateway. The connection and synchronization of the two threads or similar constructs may be handled in a shared memory location where both socket-owning threads may operate safely. The socket facing the external client may be directly connected to the external client or alternatively connect to a proxy program which either resides on the calling client, or on a network accessible to the calling client.

At 852-J the internal gateway instantiates a TCP/IP client socket connection to the internal destination endpoint (whereabouts such as host address and port number and other criteria is provided by the metadata).

At 852-K the internal and external gateways tunnel bi-directional TCP/IP byte stream, serialized using a variety of possible encoding formats, such as base64 encoding or similar, providing TCP over HTTPS (or similar) tunneling where the communication was initiated from the internal gateway to the external gateway and upon request by a client to the external gateway, the external gateway requested a bridging connection and the request is sent over the pre-existing persistent communications channel, and in response to the request by external gateway, internal gateway establishes communications to external gateway through permitted ports and protocols of logical or physical barrier such as a firewall and then the external and internal gateways collaborate using the established communications sessions to bridge the two endpoints (external client and internal server).

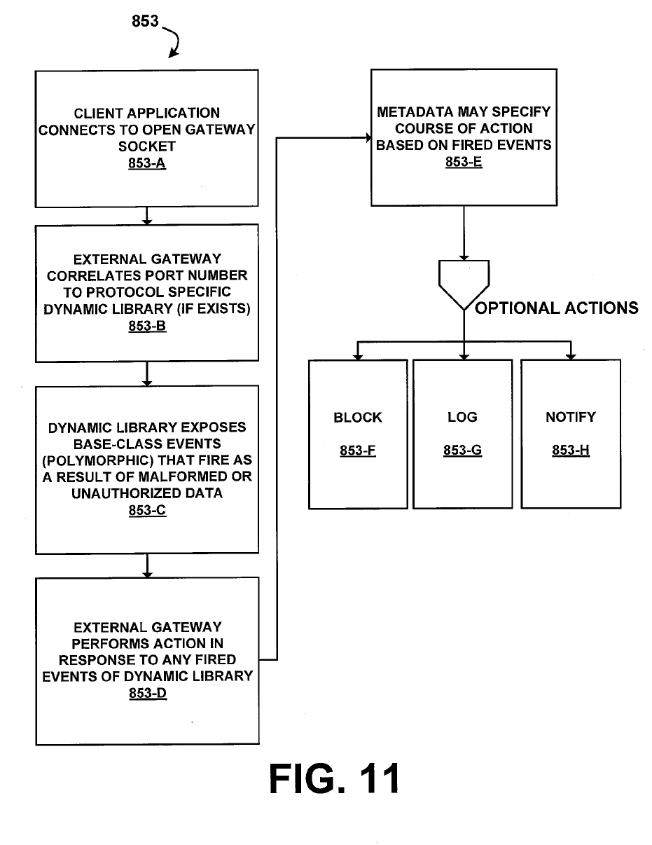

FIG. 11 illustrates aspects of a method for providing a generic gateway for accessing protected resources in accordance with some embodiments of the invention. At 853-A the client application opens a socket connection to external gateway which has a listening server socket waiting for requests. The server socket is opened as a result of the external gateway following instructions received in the metadata received from metadata service. The port number is determined from metadata and other aspects such as authentication, authorization, throttling, monitoring, logging, notification, etc. may also be governed based on metadata.

At 853-B the server may load a dynamic linked library or similar construct corresponding to the protocol associated with the TCP port as defined by metadata. The software loading the dynamic linked library contains instructions that are sufficiently intelligent to correlate protocol (as given in metadata) with a segment of dynamically loaded set of computing instructions (such as a dynamic linked library).

At 853-C the dynamic linked library which is derived from a base class that exposes a set of events that indicate various types of malformed, suspect or unauthorized data. For example, if a well known protocol has a header that must be a certain size, or not greater than a certain size, if data travels between the gateways and is processed by the dynamic linked library and the header is larger than the size allowed, the dynamic linked library will fire the event, allowing the container of the dynamic linked library (such as the external or internal gateways) to take action in response to such event. The list of events may include but is not limited to: denial-of-service, suspect-data, malformed-content, re-transmitted-data, protocol-mismatch, buffer-overrun, known-malicious-data, unexpected-data, not-enough-data, parsing-error. When the internal and/or external gateway receive such events, they may take further action is determined by metadata. For instance, the external gateway may block the caller for a configurable period of time if the event fired was suspect-data; further, the external gateway may block the caller for an indefinite period of time in response to the denial-of-service event firing. The response to the various types of events fired by the protocol specific dynamic linked libraries can be determined by either hard coding the behavior in the software or firmware of the external or internal gateway, or it may be processed in a more dynamic fashion, by interpreting the desired behavior if specified in the metadata.

At 853-D the external gateway (and optionally internal gateway in a subsequent step) may respond to events fired by the dynamic linked library as stated above. At 853-E the external or internal gateway examines its metadata which was received at an earlier step and according to instructions specified, responds to events fired by the dynamically linked library that was loaded into the gateway executing process. In 853-F the gateway may block a specific caller, either for an indefinite period of time, or for a configurable amount of time as specified in metadata. In 853-G the gateway may log the request, together with information received from the event, such as the type of event (i.e. denial-of-service, malformed data, etc.). In 853-H the gateway may cause notification to subscribing users or machines. A subscription may be defined in metadata and consists of rules such as: if a denial of service attack is perpetrated against port 25, notify user XYZ by sending an SMS message to phone number YYY and send an email to a group of users. In addition, send a synthesized voice message over a telephone to phone number ZZZ. These are merely examples of the types of notification that may be utilized. Of course, many other permutations of notifications may be utilized such as but not limited to web service call, email, WCF message, message queue message, etc.

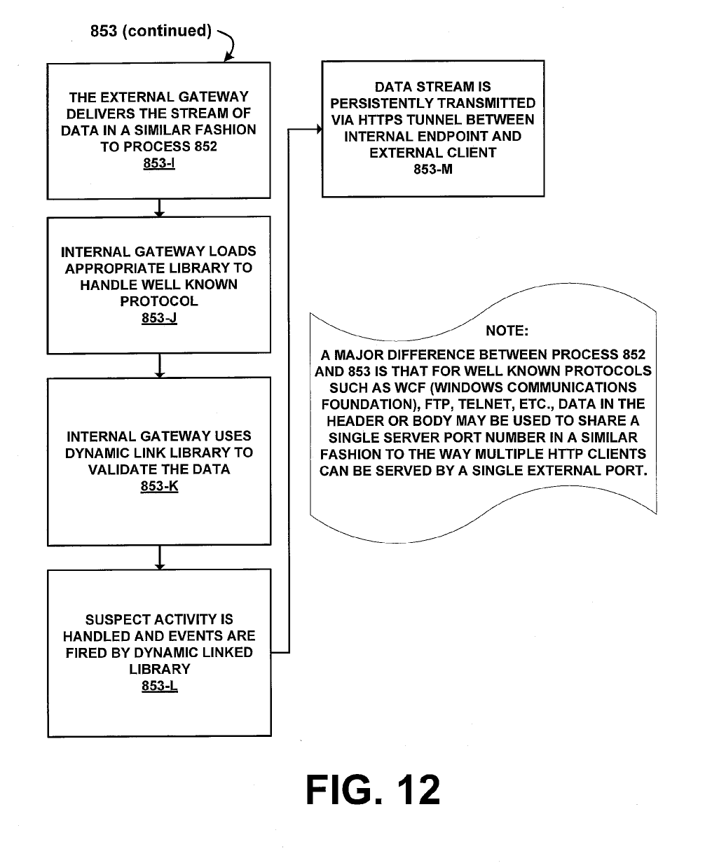

FIG. 12 is a continuation of FIG. 11. At 853-I after the dynamic linked library validated the data request and the data request correctly corresponded to the protocol associated with the port number as specified in the metadata, assuming no faults were signaled by the dynamic linked library, the external gateway streams the data received from the external client to the internal gateway over the persistent communications channel initiated from the internal gateway to the external gateway in a similar fashion to process 852.

At 853-J the internal gateway correlates the particular data communication based on external port and protocol to a dynamic linked library registered and defined in metadata. It loads the proper dynamic linked library in order to correctly handle the protocol exposed by the external gateway port. At 853-K the internal gateway uses the protocol-specific dynamic linked library to validate the data being communicated with the external gateway, fronting the external client. At 853-L the internal gateway in response to any events that may be fired by the dynamic linked library, initiates action in a similar fashion to 853-E. In 853-M assuming no events are fired by the dynamic linked library indicating unauthorized data, malformed data, malicious or suspect activity, then the two endpoints (external client and internal endpoint) communicate unhindered. The dynamic linked library may provide protocol specific translation, endpoint specific translation as defined by metadata, a combination of the two, logging, triggering of events based on specific data as defined by metadata, etc. For example, in the metadata a rule may be defined that specifies that if an order is received which complies with the order XSD (XML Schema Definition Document) and the order amount exceeds a specific amount, some action should be taken. The dynamic linked library, may because of the metadata rule initiate actions such as notification, blocking, further firing of events, etc.

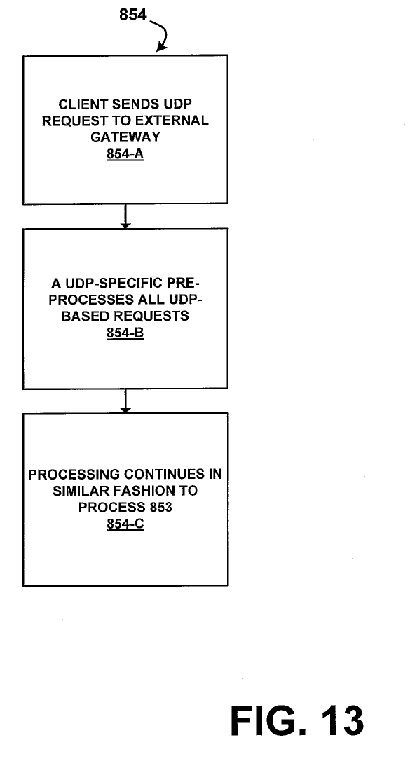

FIG. 13 illustrates aspects of a method for providing a generic gateway for accessing protected resources in accordance with some embodiments of the invention. FIG. 13 illustrates one possible embodiment corresponding to the gateway system's treatment of bridging UDP based communications from an external client that cannot under normal circumstances directly call an internal endpoint (protected behind a physical or logical barrier such as a firewall). At 854-A the client application sends UDP packets over an IP or similar network to the external gateway. The external gateway has a UDP port listening for requests based on metadata. At 854-B a dedicated module to the UDP protocol pre-processes (before more specific protocol handling modules perform processing) the request, validating that the request is valid. A known set of attack signatures may be consulted to help trigger an event corresponding to non-approved activity. Further, an approved data representation table may be consulted by the UDP pre-processing module to determine whether the data is allowed to flow or cause an event firing indicating unapproved data is being transmitted and should be stopped, logged, trigger notification, etc. At 854-C, after no events are triggered which may stop further processing of the UDP data transmission, processing continues in a similar fashion to process 853.

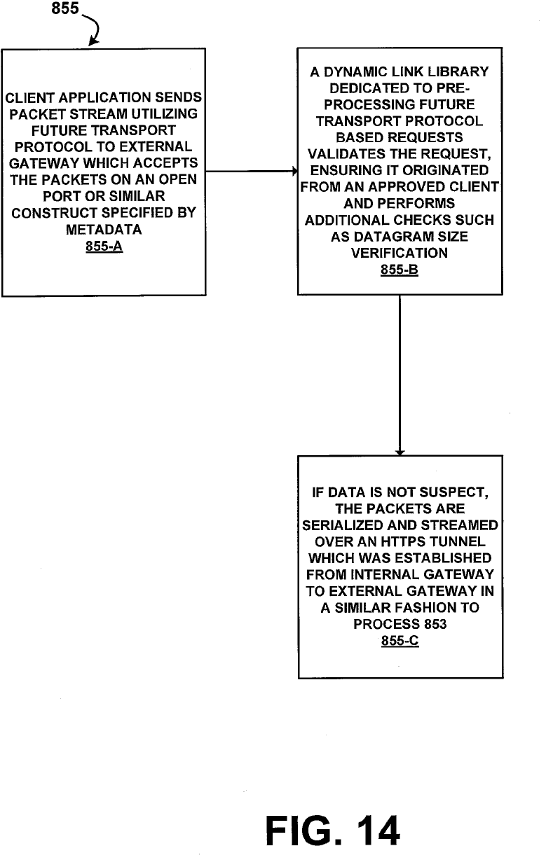

FIG. 14 illustrates aspects of a method for providing a generic gateway for accessing protected resources in accordance with some embodiments of the invention. FIG. 14 depicts a method for handling any future communications protocol or network technology. The diagram demonstrates that in addition to the embodiments described elsewhere in this document, embodiments of the invention may be used to handle any future yet to be developed protocol. At 855-A a client application sends a request over a network to external gateway. The client may utilize yet to be developed network technology and/or protocols. At 855-B both the external and internal gateways may load a dynamic linked library that contains computing instructions that perform any combination of the following processing: verification, authentication, authorization or transformation of the data transmitted from client to server and from server to client, in addition to or instead of the processing described elsewhere in this document. At 855-C if the dynamic linked library module does not raise polymorphic events that should trigger further action by one of the gateways such as blocking, logging, etc., the processing of data is handled in a similar manner to process 853.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one network adapter. One or more programs that may utilize the creation and/or implementation of domain-specific programming models aspects of the present invention, e.g., through the use of a data processing API or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

While the present invention has been described in connection with the preferred embodiments of the various figures, it is to be understood that other similar embodiments may be used or modifications and additions may be made to the described embodiments for performing the same function of the present invention without deviating therefrom. Therefore, the present invention should not be limited to any single embodiment, but rather should be construed in breadth and scope in accordance with the appended claims.

What is claimed:

1. A method for exposing to an external entity at least one resource of a plurality of resources of a private network, wherein the plurality of resources is protected by a physical or logical barrier, the method comprising:
receiving a request to access the at least one protected resource of the private network from an external entity comprising a computing device residing on a network external to the private network, wherein the request is received by an external gateway appearing to the external entity to be the at least one protected resource;
forwarding the access request from the external gateway to an internal gateway, the internal gateway applying a resource-specific, user-specified security policy over a persistent communication channel between the internal gateway and the external gateway, wherein the internal gateway establishes the persistent communication channel via ports and protocols to which access is not prohibited by the physical or logical barrier;
in response to determining that the request is valid and is authorized, forwarding the request to the at least one protected resource and forwarding the response to the request to the external gateway over the persistent communication channel

2. The method of claim 1, further comprising forwarding the response to the request to the external entity.

3. The method of claim 1, wherein the external gateway appears to the external entity to be the protected resource because the external gateway presents an interface to the external entity identical to an interface presented by the protected resource.

4. The method of claim 3, wherein the interface presented to the external entity is unprotected.

5. The method of claim 1, wherein the physical or logical barrier comprises a firewall.

6. The method of claim 1, wherein the internal gateway polls the external gateway for queued requests.

7. The method of claim 5, further comprising establishing a resource-specific security policy without requiring the firewall to be modified, wherein the resource-specific security policy is established by specifying external clients who can access the at least one protected resource and an endpoint for the at least one protected resource.

8. The method of claim 1, wherein the protected resource comprises a web service, a web application, a Microsoft Active Directory-protected web service, a Windows WCF based service, a rich client application, a message-related application, a TCP/IP-based endpoint or a SOAP-based web service not otherwise accessible by an external network.

9. A system for exposing a protected resource of a private network to an external entity comprising:
an external gateway positioned external to a firewall between an entity of a protected network and an entity of an external network, wherein the external gateway presents an interface accessible to the entity of the external network, wherein the interface exposed to the entity of the external network is identical to an actual interface presented by a resource of the protected network, the actual interface not accessible to the entity of the external network, the exposed interface appearing to the external entity to be the actual interface, wherein an internal gateway establishes a persistent connection between the internal gateway and the external gateway.

10. The system of claim 9, wherein the external gateway receives requests for the resource and stores them in a queue.

11. The system of claim 9, wherein the internal gateway continuously polls the external gateway for queued requests.

12. The system of claim 9, wherein the internal gateway applies a resource-specific, user-specified security policy to the queued requests, the resource-specific, user-specified security policy separate from a security policy applied by the firewall, the internal gateway sending only those queued requests that comply with the resource-specific, user-specified security policy to the resource.

13. The system of claim 9, further comprising a metadata store for storing metadata information concerning internal resources to be exposed to external clients.

14. The system of claim 9, wherein the resource comprises a web service, a web application, a Microsoft Active Directory-protected web service, Windows WCF based service, a rich client application, a message-related application, a TCP/IP-based endpoint or a SOAP-based web service not otherwise accessible by the entity of the external network.

15. A tangible computer-readable medium comprising computer-executable instructions for:
receiving a request to access a protected resource of a plurality of protected resources of a private network protected by a firewall from an external entity comprising a computing device residing on a network external to the private network, wherein the request is received by an external gateway appearing to the external entity to be the protected resource;
forwarding the request from the external gateway to an internal gateway over a persistent communication channel established by the internal gateway to the external gateway.

16. The tangible computer-readable medium of claim 15, comprising further computer-executable instructions for:
applying a resource-specific, user-specified security policy separate from a security policy enforced by the firewall, and in response to determining that the request complies with the resource-specific, user-specified security policy, sending the request to the external gateway via a first communication channel established by the internal gateway to the external gateway and sending the request to the protected resource via a second communication channel established by the internal gateway to the protected resource.

17. The tangible computer-readable medium of claim 16, comprising further computer-executable instructions for:
receiving a response to the compliant request from the protected resource at the internal gateway via the second communication channel established by the internal gateway to the protected resource.

18. The tangible computer-readable medium of claim 17, comprising further computer-executable instructions for:
sending the response to the external gateway from the internal gateway via the first communication channel.

19. The tangible computer-readable medium of claim 18, comprising further computer-executable instructions for:
sending the response to the external entity from the external gateway after correlating the response from the protected resource with the received request.

20. The tangible computer-readable medium of claim 15, comprising further computer-executable instructions for:
translating an interface associated with the protected resource based on metadata supplied by an authorized user, wherein the translation is performed at the internal gateway, at the external gateway, or at both the internal gateway and the external gateway, wherein the translation adapts an external interface associated with the protected resource to an internal interface associated with the protected resource or adapts the internal interface associated with the protected resource to the external interface associated with the protected resource.
